(19) United States
(12) Patent Application Publication
(10) Pub. No.: US 2019/0350395 A1
(43) Pub. Date: Nov. 21, 2019

(54) MODULAR TRAY

(71) Applicant: Universidad Nacional de Itapua, Encarnacion (PY)

(72) Inventors: Ricardo Hideto MATSUNAGA MASAOKA, La Paz - Itapua (PY); Sandra Isabel KALLUS LOBSIGER, Bella Vista - Itapua (PY); Waldy Anibal RIVEROS SAAVEDRA, Pilar Neembucu (PY); Fernando Luis GALEANO FLORES, Hohenau - Itapua (PY)

(21) Appl. No.: 16/030,111

(22) Filed: Jul. 9, 2018

(30) Foreign Application Priority Data
May 17, 2018 (PY) P 1836494

(51) Int. Cl. A47G 23/06; A47J 47/14

(52) U.S. Cl. CPC A47G 23/06; A47J 47/14

(57) ABSTRACT

Modular tray comprising a plurality of bases, a central piece to which the plurality of bases is fixed and an external ring, wherein the external ring is configured for being fixed to the bases in a zone opposite the central piece providing rigidity to the plurality of bases fixed to the central piece such that each base comprises a smaller curved side configured for being joined to the central piece, a larger curved side, and two flat sides between the smaller curved side and the larger curved side such that two contiguous bases, fixed to the central piece, have two flat contiguous sides.

### CROSS REFERENCE TO RELATED APPLICATION

This application claims priority of Paraguay Application No. P 1836494 PY filed May 17, 2018, application which is incorporated herein by reference.

### FIELD OF THE INVENTION

The invention relates to a modular tray comprising a plurality of bases which are joined to a central piece and are fixed joined to said central piece by means of an exterior ring which has an edge displaceable along each base which serves to push the content of the base, without having to touch it when the cited content of the base is consumed. The invention is applicable to the hospitality sector, both in the field of the end consumer and in the field of the kitchen, where it can also be used.

### BACKGROUND OF THE INVENTION

There are all types of trays for preparing foods and then transporting the same for theft final consumption. Pizzas, cakes and others, which are normally divided into portions, are consumed using the hands, serviettes or using utensils such as knives and forks which can have certain drawbacks such as unsuitable handling, the contamination which can be transmitted, the need for extra utensils, food falling or irritating contact with the hands, amongst other issues.

There is therefore a need to develop a tray which can ultimately be used to eat and to move the tray without having to touch the content with the hands such that the content can be divided into partial pieces and said pieces allow the content to be handled without having to touch it.

As background, an improved recipient can be mentioned for storing and transporting hot pizza in which material is saved without diminishing the structural integrity, such as the one reflected in document U.S. Pat. No. 5,472,139 dated December 1995.

There are other reusable containers made of a thermoplastic material which have lateral grooves in the portions, with removable covers such as the one reflected in the document U.S. Pat. No. 4,886,179 dated December 1989.

### DESCRIPTION OF THE INVENTION

The object of the invention is a modular tray comprising a plurality of bases, a central piece to which the plurality of bases is fixed, and an external ring such that the external ring is configured to be fixed to the bases in a zone opposite the central piece providing rigidity to the plurality of bases fixed to the central piece.

In the modular tray object of the invention, each base has a smaller curved side configured to be joined to the central piece, a larger curved side and two flat sides between the smaller curved side and the larger curved side such that two contiguous bases, when they are fixed to the central piece, have two contiguous flat sides.

In the modular tray object of the invention, the central piece comprises an upper face and a lower face such that a diametrical housing is located between the upper face and the lower face configured for fixing the bases at the smaller curved side.

The modular tray object of the invention comprises an edge associated with each base such that each edge is capable of displacing along a groove of each base by way of a tab inserted in the cited groove.

In the modular tray object of the invention, each groove is oriented radially and extends from the larger curved side to the middle of the base.

In the modular tray object of the invention, the external ring comprises a closure or joining mechanism configured to dose a circular shape of the external ring itself.

### BRIEF DESCRIPTION OF THE FIGURES

FIG. 1 shows a plan view of the modular tray object of the invention shown.

FIG. 2 shows a perspective view of a base of the modular tray object of the invention, together with the central piece to which is joined each base and an edge of those associated with each base.

FIG. 3 shows a perspective view of the external ring of the modular tray object of the invention.

FIG. 4 shows a perspective view of two bases of the modular tray object of the invention joined to the central piece and the unclosed external ring.

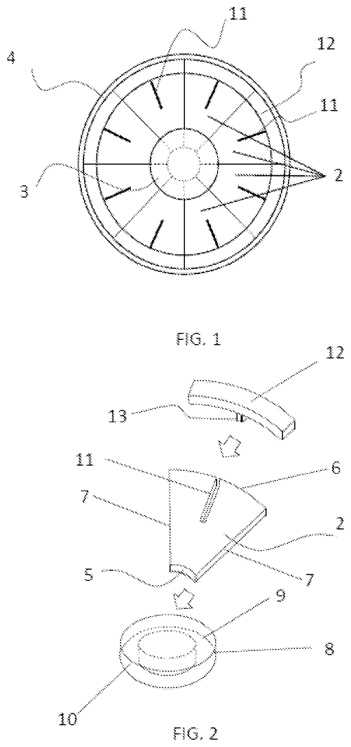

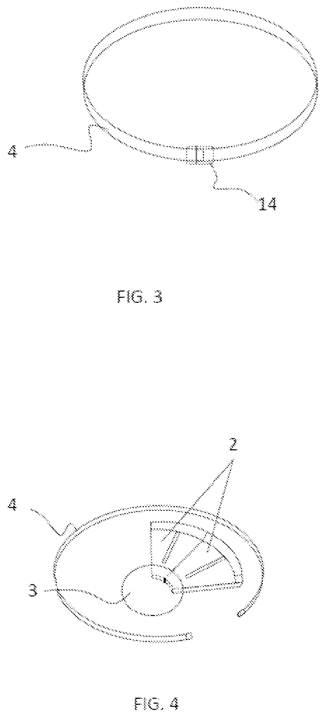

The different reference numerals which are reflected in the figures correspond to the following elements:

1. modular tray,

2. base,

3. central piece,

4. external ring,

5. smaller curved side,

6. larger curved side,

7. flat side,

8. diametrical housing,

9. upper face,

10. lower face,

11. groove,

12. edge,

13. tab,

14. closure mechanism.

### DETAILED DESCRIPTION OF THE INVENTION

The present invention relates to a modular tray (1) which comprises a plurality of bases (2) in the manner of a semi-triangle which, when joined, configure the modular tray object of the invention which, in the preferred embodiment of the invention, is circular. In addition, all the bases (2) are joined to a central piece (3) and, in turn, are joined by an external ring (4) which provides the assembly of bases (2) with rigidity,

The shape of each base (2) is a semi-triangle, with a smaller curved side (5) which is the side which is joined to the central piece (3), a larger curved side (6) and two flat sides (7) between the smaller curved side (5) and the larger curved side (6) such that two contiguous bases (2), fixed to the central piece (3), have two flat contiguous sides (7).

Between two contiguous bases (2), i.e. between the contiguous flat sides (7) of two bases (2), there is a gap that is sufficiently wide so as to introduce a cutting element to divide the food in a convenient and suitable manner.

The central piece (3) is a piece with a diametrical housing (8) configured by an upper face (9) and a lower face (10) such that between the upper face (9) and the lower face (10), a diametrical housing (8) is produced where the bases (2) are fixed at the smaller curved side (5) of the same.

Each base (2) comprises a groove (11) orientated in a radial position and extends from the larger curved side (6) to roughly the middle of the base (2).

The tray object of the invention also comprises edges (12) associated with each base (2) such that an edge (12) serving as a limit of the content of the modular tray (1), is moved along the groove (11) by means of a tab (13) inserted in the cited groove (11) and such that the edge (12) can he removed from the base (2), removing the tab (13) from the groove (11) through the larger curved side (6) of the base (2).

The displacement of the edge (12) along the groove (11) of the base (2) allows the content of the modular tray (1) to be pushed towards the smaller curved side (6) and said content can be consumed without having to interact with the content of the modular tray (1).

The external ring (4) has a closure or joining mechanism (14) which doses the circular shape of the external ring (4) itself and which, with the closure of the external ring (4), keeps the bases (2) joined to the central piece (3), providing rigidity to the assembly of bases (2), central piece (3) and ring (4) such that Et allows the easy handling of the modular tray (1) object of the invention.

1. A modular tray comprising:
a plurality of bases;
a central piece (3) to which the plurality of bases is fixed; and
an external ring;
wherein the external ring is configured for being fixed to the bases in a zone opposite the central piece providing rigidity to the plurality of bases fixed to the central piece.

2. The modular tray according to claim 1, wherein each base comprises:
a smaller curved side configured for being joined to the central piece;
a larger curved side; and
two flat sides between the smaller curved side and the larger curved side such that two contiguous bases, fixed to the central piece, have two flat contiguous sides.

3. The modular tray according to claim 1, wherein the central piece comprises:
an upper face; and
a lower face;
such that a diametrical housing is located between the upper face and the lower face configured for fixing the bases at the smaller curved side.

4. The modular tray according to claim 1, comprising an edge associated with each base such that each edge is capable of displacing along a groove of each base by way of a tab inserted in the cited groove.

5. The modular tray according to claim 4, wherein each groove is oriented radially and extends from the larder curved side to the middle of the base.

6. The modular tray according to claim 1, wherein the external ring comprises a closure mechanism configured to dose a circular shape of the external ring itself.
